(19) United States
(12) Patent Application Publication
(10) Pub. No.: US 2019/0155500 A1
(43) Pub. Date: May 23, 2019

(54) ENGLISH INPUT KEYBOARD AND INPUT METHOD USING TOUCH SCREEN OF TERMINAL

(71) Applicant: Chang-soo Jung, Uiseong-gun Gyeongsangbuk-do (KR)

(72) Inventor: Chang-soo Jung, Uiseong-gun Gyeongsangbuk-do (KR)

(21) Appl. No.: 16/093,001

(22) PCT Filed: Apr. 14, 2017
(86) PCT No.: PCT/KR2017/004048

§ 371 Date: Oct. 11, 2018

(30) Foreign Application Priority Data
Apr. 18, 2016 (KR) 10-2016-0046999

(51) Int. Cl. G06F 3/0488; G06F 3/0489

(52) U.S. Cl. CPC G06F 3/04886; G09B 19/06; G06F 3/0489

(57) ABSTRACT

The present invention relates to an English input keyboard and an input method using a touch screen of a terminal. More specifically, the present invention relates to a keyboard capable of easily inputting the English language using a keypad consisting of a total of thirteen keys, and an input method thereof. The keypad of a touch screen of the present invention consists of a total of thirteen keys in such a manner that the keypad has three rows and three columns, put in perspective, and has four separate keys in the second row and the second column, thereby securing the number of keys without the inconvenience of inputting while not having to minimize the size of each key on the touch screen of a smartphone. Furthermore, the purpose of the present invention is to enable a user to quickly and conveniently input the letters (alphabets) of the English language with a fewer number of touches.

### TECHNICAL FIELD

The present invention relates to a keyboard for inputting English alphabets in a portable terminal and an input method thereof and, more particularly, to an English keyboard which allows a user to easily and quickly input English alphabets in various portable terminals using touch screens, such as future small keypads for computer input, tablet PCs, smartphones, PDAs, navigators, MP3 players, IP TVs, kiosks, etc. and an input method thereof. These small keypads are widely used not only for conventional short message services but also for memos, Twitter activities, various data processing activities using portable information devices, etc. and have attracted attention as simple letter input means in IP TVs, etc.

Moreover, the present invention relates to a method of inputting letters in a portable terminal and, more particularly, to a keyboard for inputting letters in a portable terminal having a touch screen and an input method thereof, which allows a user to more easily input letters when a plurality of letters are assigned to a single key in a method of displaying a virtual keypad on a display and inputting a letter by detecting a touch in a specific key area.

### BACKGROUND ART

The English alphabet has 26 letters, but in the case of a smartphone having a 12 (3×4) key layout, it is limited in size, and it is difficult to input the alphabet.

The methods of inputting English alphabets can be roughly divided into a method of repeatedly arranging 3 to 4 letters on a single key (called a multi-tap method) and a QWERTY keyboard on a computer. The multi-tap method has a disadvantage in that the number of times of pressing a key increases for a letter that comes later because a plurality of letters are repeatedly arranged on a single key.

In particular, the multi-tap method has a structure in which the letters are arranged in a lexicographic order regardless of frequency of use and has a disadvantage in that a key must be pressed several times in order to input the most frequently used letter. Moreover, if a user needs to consecutively input the same letter or the letters which are repeatedly arranged on a single key, the user can input the next letter only when the cursor moves to the next letter string after the cursor blinks three times regardless of the user's skill. Moreover, if the timing is not correct, an error in which another letter of the same string is input may occur.

Meanwhile, in the case of the QWERTY layout, since the 26 letters of the English alphabet are arranged on a narrow keyboard, the size of a single key is too small, and the interval between the keys is narrow, resulting in a lot of typos. Moreover, when a QWERTY keyboard is used on a small smartphone, the user cannot use all fingers, like on a computer. Furthermore, even if the user uses both hands, the user can only use two fingers, and thus there is a limit to the input speed. The difficulty of inputting letters ultimately hinders miniaturization of the device.

For reference, Korean Patent No.: 11682113, filed by the present applicant, relates to a method of inputting Korean (English) letters and numbers, which is the parent application of the present application.

### DISCLOSURE

### Technical Problem

Accordingly, the present invention has been made to overcome the above-mentioned conventional problems, and it is an object of the present invention to provide a keyboard for inputting alphabets and an input method thereof, which is consistent with the characteristics of the English alphabet to allow a user to quickly and conveniently input English alphabets.

Moreover, another object of the present invention is to provide a keyboard for inputting English alphabets in a portable terminal and an input method thereof, which can reduce the number of keys, the number of times of pressing the keys, and the fingering distance and allow a user to efficiently use both hands based on the principle of the English word structure, thereby allowing the user to effectively inputting letters which are repeatedly arranged on a single key.

### Technical Solution

To achieve the above-mentioned objects, according to an aspect of the present invention, the present invention provides a keyboard for inputting English alphabets on a touch screen of a terminal, the keyboard having a key structure in which keys are arranged in three rows and three columns, the keys in the second row and second column comprising a central key 12 and four inner keys 14 arranged around the central key in four directions, characterized in that 26 English letters (alphabets) are arranged on a total of 11 keys consisting of the central key 12, two inner keys among the four inner keys 14 around the central key, and eight outer keys 16; and the remaining two inner keys 14 on which the letters are not arranged are used as auxiliary keys for inputting letters.

According to an embodiment of the present invention, a total of 21 consonants consisting of b, c, d, f, g, h, j, k, l, m, n, p, q, r, s, t, v, w, x, y and z are dispersedly arranged on a total of 9 keys including the eight outer keys 16 and the central key 12, and a total of 5 vowels consisting of a, e, o and u are dispersedly arranged on the central key 12, two inner keys among the four inner keys 14 around the central key in four directions, the outer key 16 in the first row and second column, and the outer key 16 in the third row and second column.

According to an embodiment of the present invention, the number 0 is arranged on the central key 12, each two of the numbers 1, 2 and 3 are dispersedly arranged on the four inner keys 14 and the outer keys 16 in the second row, and the numbers 4 to 9 are dispersedly arranged on the remaining six outer keys 16.

According to another aspect of the present invention, the present provides a method of inputting English alphabets on a touch screen of a terminal using the above-described keyboard, characterized in that in order to input 21 consonants and 5 vowels on a total of 11 keys consisting of the central key, the two inner keys, and the eight outer keys, the first arranged letter on each key is input by pressing the corresponding key; the second arranged letter is input by pressing the corresponding key and then pressing one of the two auxiliary keys of the inner keys 14 once; and the third arranged letter is input by pressing the corresponding key and then pressing one of the two auxiliary keys of the inner keys 14 twice consecutively.

According to an embodiment of the present invention, by using a combination of one of the two auxiliary keys of the inner keys and one of the outer keys, a user can directly register a word or phrase and directly retrieve the registered word or phrase to input it.

Prior to this, the terms or words used in the specification and claims of the present application should not be construed as being limited to ordinary or dictionary meanings, but should be construed as meanings and concepts conforming to the technical spirit of the present invention on the basis of the principle that the inventor can define the concept of the terms properly to explain his invention in the best way. Accordingly, it should be understood that embodiments described in the specification and the configurations shown in the drawings are just the most preferred embodiments of the present invention and do not fully cover the spirit of the present invention, and thus there may be various equivalents and modifications that can replace these embodiments at the time of filing this application.

### Advantageous Effects

As described above, the keyboard for inputting English alphabets on a touch screen of a terminal and the input method thereof of the present invention can allow users to quickly input the English alphabets and to use both hands equally, thereby achieving convenience and satisfaction at the same time.

The above-described keypad layout for a touch screen of a portable terminal, etc. according to the present invention can minimize the number of times of pressing the keys so that the user can more easily input letters than using a conventional keypad layout consisting of 12 keys and can ensure sufficient space for the keys on which the letters are arranged in a small portable device, compared to the QWERTY keyboard, thereby facilitating the efficiency of inputting letters.

Moreover, the method of inputting English alphabets on a touch screen of a terminal according to the embodiments of the present invention can prevent typos because the area assigned to a single key is wider than the QWERTY layout.

Furthermore, the method of inputting English alphabets on a touch screen of a terminal according to the embodiments of the present invention arranges the most frequently used alphabets at the first position of the respective keys to thereby generally reduce the number of key touches and eliminate the inconvenience of having to wait for a certain period of time until the cursor moves to the next letter string after the cursor blinks three times, even when inputting the same letter or consecutively inputting different letters arranged on the same key.

### DESCRIPTION OF DRAWINGS

FIG. 1 is a diagram showing the overall configuration of an English keyboard according to the present invention.

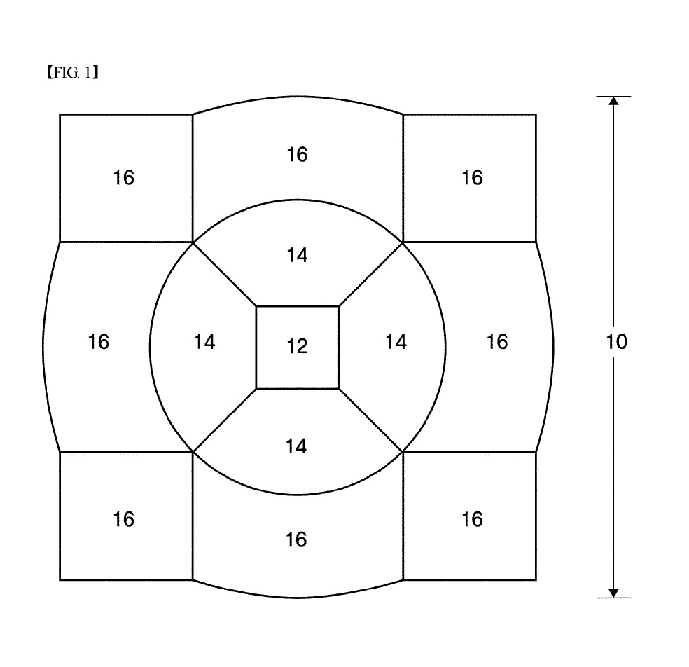

FIG. 2 is an exemplary diagram showing a specific layout of letters for an English keyboard according to the present invention.

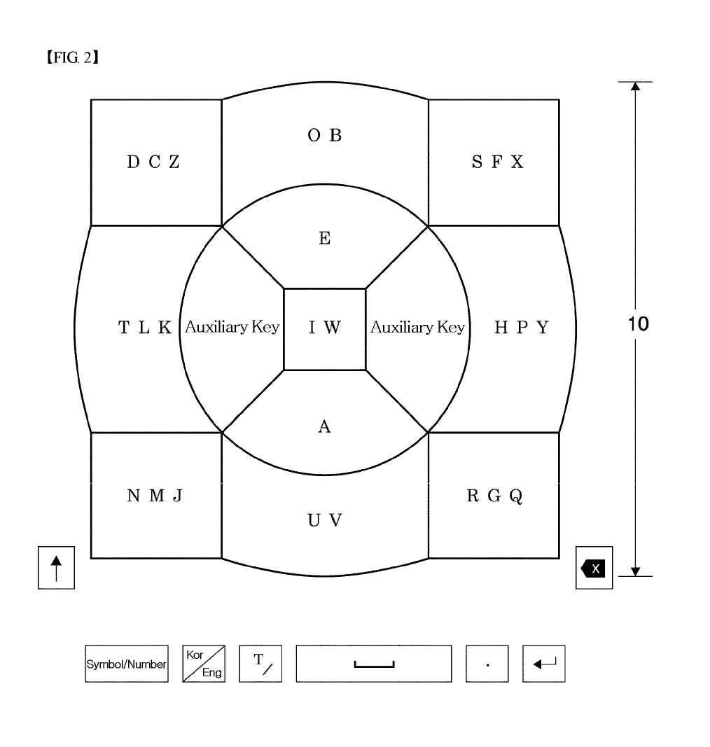

FIG. 3 is an exemplary diagram showing a specific layout of numbers for a numeric keyboard according to the present invention.

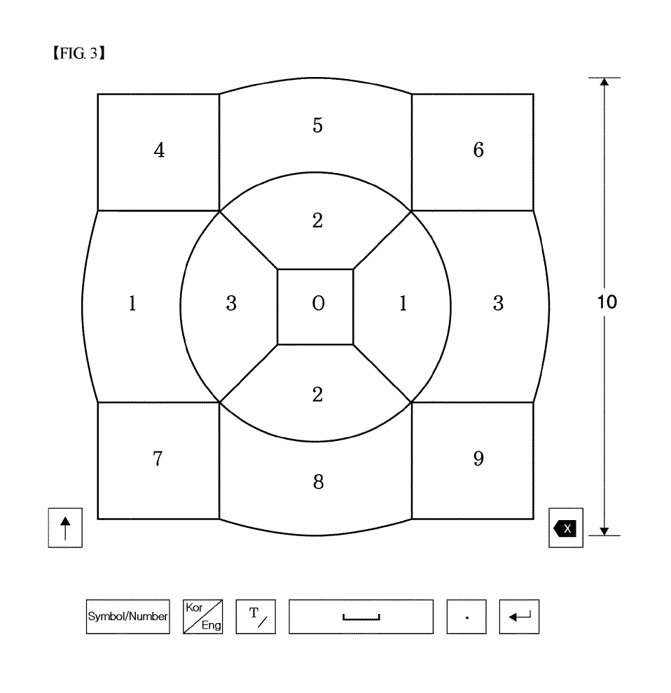

### BEST MODE FOR CARRYING OUT THE INVENTION

The present invention provides a keyboard for inputting English alphabets on a touch screen of a terminal, the keyboard having a key structure in which keys are arranged in three rows and three columns, the keys in the second row and second column comprising a central key 12 and four inner keys 14 including two auxiliary keys and arranged around the central key in four directions, and the keyboard further comprising eight outer keys 16 arranged around the inner keys, characterized in that a total of 21 consonants consisting of b, c, d, f, g, h, j, k, l, m, n, p, q, r, s, t, v, w, x, y and z are dispersedly arranged on the outer keys 16 and the central key 12, and a total of 5 vowels consisting of a, e, i, o and u are dispersedly arranged on a total of 5 keys including the central key 12, two inner keys 14 among the four inner keys 14, the key in the first row and second column, and the key in the third row and second column, and the number 0 is arranged on the central key 12, each two of the numbers 1, 2 and 3 are dispersedly arranged on the inner keys 14 and the outer keys 16 in the second row, and the numbers 4 to 9 are dispersedly arranged on the remaining six outer keys 16, thereby also allowing a user to input numbers.

Moreover, the present invention provides a method of inputting English alphabets on a touch screen of a terminal using the above-described keyboard, characterized in that among the alphabets arranged on the outer keys 16, the inner keys 14, and the central key 12, the alphabet which is arranged on a single key or the first arranged alphabets on the keys where the alphabets are repeated arranged are input by pressing the corresponding key once; the second arranged alphabets on the keys where the alphabets are repeated arranged are input by pressing the corresponding key and then pressing one of the two auxiliary keys of the inner keys once; and the third arranged alphabets on the keys where the alphabets are repeated arranged are input by pressing the corresponding key and then pressing one of the two auxiliary keys of the inner keys twice consecutively.

### [Mode for Invention]

Hereinafter, embodiments of the keyboard for inputting English alphabets on a touch screen of a terminal and the input method thereof of the present invention will be described in detail with reference to the accompanying drawings.

The keyboard for inputting English alphabets on a touch screen of a terminal according to the present invention has a key structure consisting of a total of 13 keys based on the ideas including the Yin-Yang and Five-Element theories.

Specifically, the keyboard of the present invention has a key structure of three rows and three columns, and a total of 5 Five-Element keys including a central key 12 and four inner keys 14 arranged around the central key in four directions plus a total of 8 outer keys 16 arranged around the inner keys are called Yin-Yan and Five-Element keys.

The keyboard of the present invention consists of a total of 13 keys including one central key 12, four inner keys 14 arranged around the central key 12, and eight outer keys 16 arranged around the inner keys.

According to an embodiment of the present invention, the keyboard is configured by classifying the letters that make up English words in accordance with the Yin-Yan and Five-Element keys and arranging the classified letters on the keys in accordance with their characteristics as much as possible.

In general, the consonants belong to the Yin-Yang, and the Yin-Yang is expanded to Eight Aspects via Four Aspects by two changes. Thus, 21 consonants are arranged on the eight outer keys 16 and the central key 12 of the Five-Element keys.

English has five vowels, which are uniformly arranged in the second column including the central key.

According to an embodiment of the present invention, the reason that each three of the consonants are collectively arranged in the first and third columns when they are arranged on the central key 12 and the eight outer keys 16 is that the fingering distance between both hands during input and the combination with the auxiliary keys are taken into account. Users mainly use the thumbs of both hands to input text on smartphones, and thus a large number of consonants are arranged in the first and third columns that are closer to the thumbs of both hands.

According to an embodiment of the present invention, the consonants which are repeatedly arranged on the same key are arranged according to frequency of use. This is to reduce the number of input strokes by arranging the most frequently used letters at the first position. Then, the second most frequently used letters are arranged at the second position, and the least frequently used letters are arranged at the third position so as to facilitate the input of the letters.

Moreover, in connection with the use of the letters, the letters are arranged so that the user can use both hands alternately or minimize the fingering distance during input based on the correlation between the letters. For example, in the case of the consecutive consonants, such as t and h, s and t, and n and g, if the user inputs such consonants with one hand, the fatigue of the finger increases.

According to Samuel Morse who invented the Morse code, among the English alphabets, E is the most frequently used, followed by T, A, I, N, O, S, H, R, D, L and U in this order. These most frequently used alphabets are arranged at the first position of each key and thus can be input by one touch. Then, the remaining alphabets are arranged at the second and third positions in the order of decreasing frequency.

In particular, the most frequently used vowels E, A and I are arranged on the central key and the inner keys in the second column that the thumbs can access fast, thereby allowing the user to easily and quickly input the corresponding vowels. The reason that the consonant T is arranged in the second row and first column is that the most frequently used words start with T, such as “the” and “that”. Moreover, the semivowel W has the characteristics of the vowel and thus is arranged on the central key 12 together with the vowels.

By arranging the consonants mainly on the outer keys 16 and the vowels mainly in the second column, when the user inputs letters using the thumbs of both hands, the thumbs do not move horizontally, but move diagonally in almost all cases, and thus it is much easier to input the letters in of the body structure. Moreover, there is an advantage that the fingers can easily memorize the keys from simple movement of fingers through repeated input.

Therefore, the repeated use of this keyboard helps the users to learn English more easily because the users can see what kinds of relationship the respective alphabets have as well as know the meaning of the invisible hieroglyphs that the alphabets have.

According to the embodiment of the present invention, the number 0 is arranged on the central key 12, each two of the numbers 1, 2 and 3 are dispersedly arranged on the inner keys 14 and the outer keys 16 in the second row, and the numbers 4 to 9 are dispersedly arranged on the remaining six outer keys 16. The reason that the number 0 is arranged on the central key 12 in the center of the Five-Element keys is that the number 0 represents the center of the Five-Elements, which serves as a channel for communication with the Three Components of the Universe (Heaven, Earth and Human; the numbers 1, 2 and 3). The reason that the numbers 1 to 3 are arranged on the inner keys 14 of the Five-Element keys and the outer keys 16 in the second row is that the Three Components represented by the numbers 1, 2 and 3 are deeply involved in the communication process. The numbers 4 to 9 can be arranged on the remaining keys in various ways to accommodate changes in the communication process of the ideas.

According to another aspect of the present invention, the present invention provides a method of inputting English alphabets on a touch screen of a terminal using the above-described keyboard, characterized in that the letter (alphabet) which is arranged on a single key or the first arranged letters (alphabets) on the keys where the letters (alphabets) are repeated arranged are input by pressing the corresponding key once; the second arranged letters on the keys where the letters are repeated arranged are input by pressing the corresponding key and then pressing one of the two auxiliary keys of the inner keys 14 once; and the third arranged letters on the keys where the letters are repeated arranged are input by pressing the corresponding key and then pressing one of the two auxiliary keys of the inner keys 14 twice consecutively.

By doing so, all letters can be input by at most three key touches. In particular, the most frequently used letter can be input by one touch and thus can be input quickly.

In particular, the second and third arranged letters (alphabets) on the keys where the alphabets are repeated arranged are input by pressing a combination of the corresponding key and the auxiliary keys of the inner keys 14, and thus it is possible to eliminate the disadvantages of having to wait for a certain period of time until the cursor moves to the next letter string after the cursor blinks three times regardless of the user's skill, when inputting the same letter or consecutively inputting different letters arranged on the same key, which may occur in the multi-tap method.

The reason that the two keys of the inner keys 14 are designated as auxiliary keys is to allow the user to input the letters arranged on the left side together with the right auxiliary key of the inner keys and the letters arranged on the right side together with the left auxiliary key of the inner keys, and thus the user can always use both hands equally and input the letters quickly.

According to an embodiment of the present invention, with the use of a combination of one of the two auxiliary keys of the inner keys 14 and one of the outer keys 16, the user can directly register a word or phrase and directly retrieve the registered word or phrase to input it. By doing so, it is possible to input a long word or sentence with just four touches.

For example, if the user registers “Good morning”, one of the frequently used greetings, as a phrase, the user can input the phrase with just four touches. In particularly, by providing two channels such as words and phrases, the users can quickly input the most frequently used words and phrases as well as long sentences.

In the above-described input method using words or phrases, the user of the portable terminal can store at least one of preset words or phrases and most frequently used words or phrases previously in a memory such that it can be automatically retrieved by an algorithm defined in a main input section of the keyboard and then input.

It will be apparent to those skilled in the art that the present invention is not limited to the embodiments described above, but various modifications and variations can be made without departing from the spirit and scope of the invention. Thus, it is intended that the present invention covers such modifications and variations as come within the scope of the appended claims and their equivalents.

### INDUSTRIAL APPLICABILITY

As described above, the present invention relates to a keyboard for inputting English alphabets on a touch screen of a terminal, the terminal is intended for portable terminals with relatively small input and display areas, but is not limited thereto, and may include various portable terminals using touch screens, such as future small keypads for computer input, tablet PCs, PDAs, navigators, MP3 players, IP TVs, kiosks, etc. All devices are equipped with a microprocessor, a memory, and an input/output interface so as to handle input and output to and from a touch screen. Therefore, the keyboard of the present invention is displayed on the touch screen according to an algorithm pre-stored in a memory and, at the same time, performs input through the touch screen.

1. A keyboard for inputting English alphabets on a touch screen of a terminal, the keyboard having a key structure in which keys are arranged in three rows and three columns, the keys in the second row and second column comprising a central key 12 and four inner keys 14 including two auxiliary keys and arranged around the central key in four directions, and the keyboard further comprising eight outer keys 16 arranged around the inner keys, characterized in that a total of 21 consonants consisting of b, c, d, f, g, h, j, k, l, m, n, p, q, r, s, t, v, w, x, y and z are dispersedly arranged on the outer keys 16 and the central key 12, and a total of 5 vowels consisting of a, e, i, o and u are dispersedly arranged on a total of 5 keys including the central key 12, two inner keys 14 among the four inner keys 14, the key in the first row and second column, and the key in the third row and second column.

2. The keyboard of claim 1, wherein the number 0 is arranged on the central key 12, each two of the numbers 1, 2 and 3 are dispersedly arranged on the inner keys 14 and the outer keys 16 in the second row, and the numbers 4 to 9 are dispersedly arranged on the remaining six outer keys 16, thereby also allowing a user to input numbers.

3. The keyboard of claim 1, wherein three letters are repeatedly arranged on the keys in the first, second and third rows of the first column and in the first, second and third rows of the third column and two letters are repeatedly arranged on the central key 12 and the keys in the first and third rows of the second column.

4. A method of inputting English alphabets on a touch screen of a terminal using the keyboard of claim 1, characterized in that among the alphabets arranged on the outer keys 16, the inner keys 14, and the central key 12, the alphabet which is arranged on a single key or the first arranged alphabets on the keys where the alphabets are repeated arranged are input by pressing the corresponding key once; the second arranged alphabets on the keys where the alphabets are repeated arranged are input by pressing the corresponding key and then pressing one of the two auxiliary keys of the inner keys once; and the third arranged alphabets on the keys where the alphabets are repeated arranged are input by pressing the corresponding key and then pressing one of the two auxiliary keys of the inner keys twice consecutively.

5. The method of claim 4, wherein, by using a combination of one of the two auxiliary keys of the inner keys 14 and one of the outer keys 16, a user can directly register a word or phrase and directly retrieve the registered word or phrase, or the user can store at least one of preset words or phrases and most frequently used words or phrases previously in a memory such that it can be automatically retrieved by an algorithm of an input system and then input.
